(19) United States
(12) Patent Application Publication
(10) Pub. No.: US 2014/0067584 A1
(43) Pub. Date: Mar. 6, 2014

(54) INTEGRATED SYSTEM FOR AUTOMATED CREATION OF CONTRACT

(71) Applicants: SACHIN SHARMA, MUMBAI (IN); CHITRESH JAIN, MUMBAI (IN)

(72) Inventors: SACHIN SHARMA, MUMBAI (IN); CHITRESH JAIN, MUMBAI (IN)

(21) Appl. No.: 13/687,638

(22) Filed: Nov. 28, 2012

(30) Foreign Application Priority Data
Aug. 29, 2012 (IN) 2510/MUM/2012

(51) Int. Cl. G06Q 30/06

(52) U.S. Cl. CPC G06Q 30/0611
USPC 705/26.3

(57) ABSTRACT

The present invention discloses an integrated system for automated creation of contract which is adapted for flipping the information from RFQ present in Auction and Bids Information System (iSource) and information present in requisition from e-procurement system into contract; said system comprising: a processor unit; and a computer readable medium storing instructions executable by the processor unit further comprising: Retrieval System to retrieve the necessary information from RFQ for different suppliers present in Auction and Bids Information System (iSource) and from requisition present in e-procurement system; Storing System to store the retrieved information of RFQ and requisition on a computer readable storage medium; Mapping System to map the information of RFQ and requisition with contract fields; Metadata Flipping System, adapted to flip the mapped information from RFQ and requisition into metadata; and Contract Creating System, adapted to create contract from the information of metadata. Present system saves time of entering information on contract template manually.

### CROSS-REFERENCE TO RELATED APPLICATION

The instant application claims priority to Indian Patent Application Ser. No. 2510/MUM/2012, filed Aug. 29, 2012, pending, the entire specification of which is expressly incorporated herein by reference.

### FIELD OF THE INVENTION

The present invention generally relates to electronic procurement, and more specifically to an integrated system for the automated creation of contracts.

### BACKGROUND OF THE INVENTION

U.S. Patent Application Publication No. 2004215467 describes a system and method for the electronic generation of a request for quote (“RFQ”). U.S. Patent Application Publication No. 2002007324 describes a system and method that facilitates communications and commercial transactions between buyers and suppliers that further helps to form a contract between the buyer and supplier. However, in this case, the contract is not made by an automated process. There are many other conventional systems and/or methods for contract management; however, none of them provide systems and/or methods which provide for the automated creation of contracts.

Accordingly, there exists a need for new and improved systems for the automated creation of contracts that overcome at least one of the aforementioned problems.

### SUMMARY OF THE INVENTION

In accordance with the general teachings of the present invention, an integrated system is provided for the automated creation of contracts. In accordance with one aspect if the present invention, the system includes the integration of a contract database with an auction and bids information system and an e-procurement system. The auction and bids information system contains a RFQ and/or request for information (“RFI”) sent by a buyer to different suppliers, while the e-procurement system is intended to provide for an electronic procurement process for goods/services. By way of a non-limiting example, the present invention may be adapted to create a contract between a buyer and supplier by accessing information from the RFQ and/or RFI and the requisition. Thus, for example, the present invention may save the time of manually entering information on a contract template.

An object of the present invention is to provide an integrated system for the automated creation of a contract.

Another object of the present invention is to provide a system containing an integration of a contract database with an auction and bids information system and an e-procurement system.

Yet another object of the present invention to provide an integrated system adapted for flipping the information from a RFQ and/or RFI of an auction and bids information system and from a requisition of an e-procurement system into a contract template based at least upon one or more decision rules.

In accordance with one embodiment of the present invention, an integrated system is provided for the automated creation of a contract which is adapted for flipping the information from a RFQ and/or RFI present in an auction and bids information system and information present in a requisition from an e-procurement system into a contract.

In accordance with another embodiment of the present invention, the system includes a processor unit and a computer readable medium storing instructions executable by the processor unit, the system further including a retrieval system to retrieve the necessary information from a RFQ and/or RFI for different suppliers present in an auction and bids information system and from a requisition present in an e-procurement system, a storing system to store the retrieved information of the RFQ and/or RFI and the requisition on a computer readable storage medium, a mapping system to map the information of the RFQ and/or RFI and the requisition with contract fields, a metadata flipping system adapted to flip the mapped information from the RFQ and/or RFI and the requisition into metadata, and a contract creating system adapted to create a contract from the information of the metadata.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will now be described in relation to the accompanying drawings in which:

FIG. 1 illustrates a schematic of a system containing an integration of a contract database with an auction and bids information system and an e-procurement system, in accordance with a first embodiment of the present invention; and

FIG. 2 illustrates the primary steps for the automated creation of a contract according to the general teachings of the present invention, in accordance with a second embodiment of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

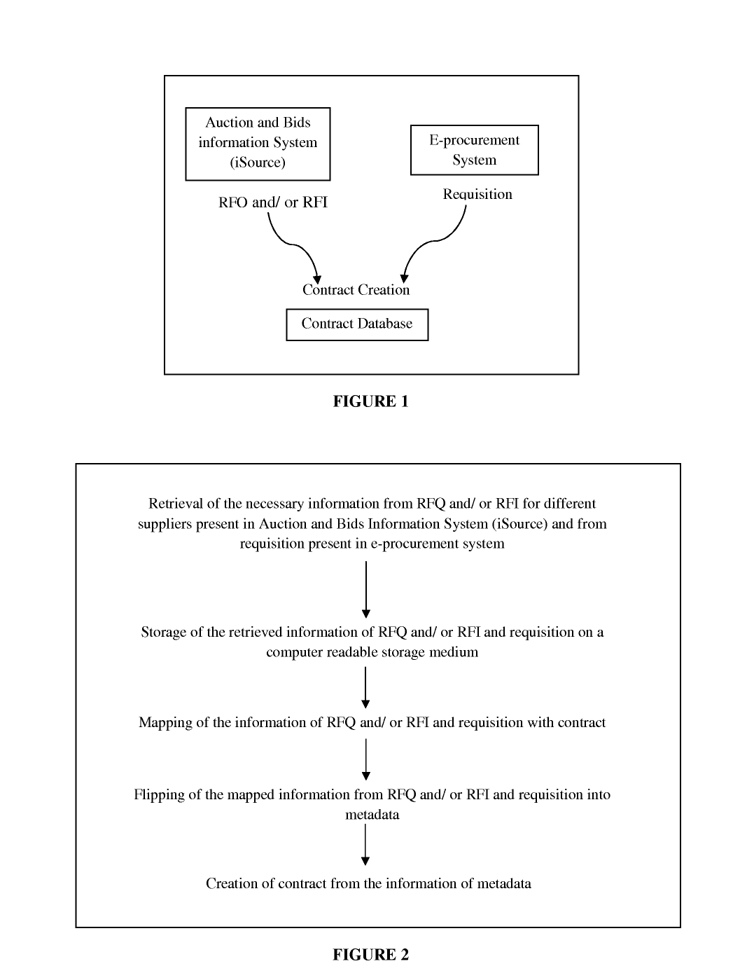

Referring to FIGS. 1-2, there is provided a database of contracts of suppliers. So while creating the contract which is present in this database, the required information will automatically be fetched from the RFQ and/or RFI for different suppliers, present in an auction and bids information system as well as from a requisition, approved for raising a purchase order (“PO”), present in an e-procurement system.

The auction and bids information system, wherein, before providing bids for an auction, bidders fill in information about their product details, prices of products, RFQ, and/or the like. The RFQ is information corresponding to the set of questions which are present in standard format.

The e-procurement system may be adapted for an automated procurement process which includes searching the catalog in the catalog database, the selection of good(s) or service(s), the approval of the requisition by the purchase department, the raising of the PO and invoice(s).

According to the present system, information flows into the contract database from the auction and bids information system and e-procurement system. The retrieved information may be mapped based on at least one or more decision rules. Thereafter, the mapped information may be flipped into metadata, which may be further flipped into the contract template.

By way of a non-limiting example, an integrated system is provided for automated contract creation, adapted for flipping the information from the RFQ and/or RFI present in the auction and bids information system and information present in the requisition from the e-procurement system into contract; the system comprising:

a processor unit; and

a computer readable medium storing instructions executable by the processor unit comprising:

a retrieval system to retrieve the necessary information from the RFQ and/or RFI for different suppliers present in the auction and bids information system and from the requisition present in the e-procurement system;

a storing system to store the retrieved information of the RFQ and/or RFI and the requisition on a computer readable storage medium;

a mapping system to map the information of the RFQ and/or RFI and the requisition with contract fields;

a metadata flipping system adapted to flip the mapped information from the RFQ and/or RFI and the requisition into metadata; and

a contract creating system adapted to create a contract from the information of the metadata.

By way of another non-limiting example, mapping of information from the RFQ and/or RFI present in an auction and bids information system and the information from the requisition present in the e-procurement system with contract fields is based at least upon one or more pre-configured decision rule(s). These decision rule(s) may include assigning a common unique identifier to fields in the RFQ and/or RFI of the auction and bids information system or the requisition of the e-procurement system and corresponding fields of the metadata and the contract. For example, if in metadata, the field used is the supplier name and in the contract template, the field used is vendor name. Mapping is then done by assigning an identifier to these common fields.

By way of still another non-limiting example, a contract creating system may be adapted for creating contract(s) by flipping the information from the metadata into the contract template, which may be further adapted for adding clause(s) to create a new contract.

The present invention thus facilitates the user to define the common fields in the contract.

The fields which can be more common in the contract, which can appear in metadata, include, but are not limited to: contract category; contract subcategory; contract title; date of contract; product type; supplier name; value of contract; contract number; contract status; start date; expiry date; renewal date; payment terms; total value; stake holder information; contract contact person; signing authority; authorities information; jurisdiction; and/or whether arbitration is allowed.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An integrated system for the automated creation of a contract, the system adapted for flipping information from a request for quote or a request for information present in an auction and bids information system and information present in a requisition from an e-procurement system into a contract, the system comprising:
a processor unit; and
a computer readable medium storing instructions executable by the processor unit comprising:
a retrieval system to retrieve the necessary information from the request for quote or the request for information for different suppliers present in the auction and bids information system and from the requisition present in the e-procurement system;
a storing system to store the retrieved information of the request for quote or the request for information and the requisition on the computer readable storage medium;
a mapping system to map the information of the request for quote or the request for information and the requisition with contract fields;
a metadata flipping system adapted to flip the mapped information from the request for quote or the request for information and the requisition into the metadata; and
a contract creating system adapted to create the contract from the information of the metadata.

2. The system according to claim 1, wherein the mapping of information from the request for quote or a request for information present in the auction and bids information system and the information from the requisition present in the e-procurement system with contract fields based at least upon one or more pre-configured decision rules.

3. The system according to claim 2, wherein the decision rules include assigning a common unique identifier to fields in the request for quote or the request for information of the auction and bids information system or the requisition of the e-procurement system and corresponding fields of the metadata and the contract.

4. The system according to claim 1, wherein, the contract creating system is adapted for creating contracts by flipping the information from the metadata into a contract template.

5. The system according to claim 1, wherein the contract creating system is adapted for adding at least one clause to create a new contract.

6. The system according to claim 1, wherein the system facilitates a user to define a common field in the contract.

7. A method for the automated creation of a contract, the method adapted for flipping the information from a request for quote or a request for information present in an auction and bids information system and information present in a requisition from an e-procurement system into the contract, the method comprising the steps of:
retrieving any necessary information from the request for quote or the request for information for different suppliers present in the auction and bids information system and from the requisition present in the e-procurement system;
storing the retrieved information of the request for quote or the request for information and the requisition on a computer readable storage medium;
mapping of the information of the request for quote or the request for information and the requisition with contract fields;
flipping the mapped information from the request for quote or the request for information and the requisition into metadata; and
creating a contract from the information of the metadata.

8. The method according to claim 7, wherein the method of mapping of information from the request for quote or the request for information present in the auction and bids information system and the information from the requisition present in the e-procurement system with contract fields is based at least upon one or more pre-configured decision rules.

9. The method according to claim 7, wherein the method further comprises the step of creating decision rules which includes assigning a common unique identifier to fields in the request for quote or the request for information of the auction and bids information system or the requisition of the e-procurement system and corresponding fields of the metadata and the contract.

10. The method according to claim 7, wherein the step of creating the contract is adapted for creating contracts by flipping the information from the metadata into a contract template.

11. The method according to claim 7, wherein the step of creating the contract is adapted for adding clauses to create a new contract.

12. The method according to claim 7, wherein the method facilitates a user to define the common fields in the contract.
